(19) United States
(12) Patent Application Publication
(10) Pub. No.: US 2020/0394560 A1
(43) Pub. Date: Dec. 17, 2020

(54) System and Method for Generating Training Materials for a Video Classifier

(71) Applicant: OSR ENTERPRISES AG, Cham (CH)

(72) Inventors: Yosef BEN-EZRA, Petah Tikva (IL); Samuel HAZAK, Holon (IL); Yaniv BEN-HAIM, Kfar Mordechai (IL); Yoni SCHIFF, Yahud (IL); Shai NISSIM, Tel Aviv (IL); Orit SHIFMAN, Petach Tikva (IL)

(21) Appl. No.: 16/766,682

(22) PCT Filed: Sep. 5, 2018
(86) PCT No.: PCT/IL2018/050985

§ 371 Date: May 24, 2020

Related U.S. Application Data
(60) Provisional application No. 62/554,689, filed on Sep. 6, 2017.

(51) Int. Cl. G06N 20/00; G06N 5/04

(52) U.S. Cl. CPC G06N 20/00; G06N 5/04

(57) ABSTRACT

A method, system and computer program product for generating content for training a classifier, the method comprising: receiving two or more parts of a description; for each part, retrieving from an extracted feature collection library one or more extracted feature collections derived from one or more video frames, the extracted feature collections or the video frames labeled with a label associated with the part, thus obtaining a multiplicity of extracted feature collections; and combining the multiplicity of extracted feature collections to obtain a combined feature collection associated with the description, the combined feature collection to be used for training a classifier.

### TECHNICAL FIELD

The present disclosure relates to video classifiers in general, and to generating training materials for a video classifier in particular.

### BACKGROUND

As computerized vision applications are developing, larger and larger training corpuses of video are required for training classifiers in order to identify elements and situations within video frames or sequences. One particular need relates to training materials required for classifying videos captured by autonomous cars.

Such cars need to be trained on a huge amount of videos, in order to ensure that almost any possible driving situation and behavior is covered, such that the car is trained to react safely when a similar situation occurs. For example, a training corpus should cover situations captured in various weathers; environments such as urban, flat countryside, hilly countryside, desert, etc.; various lighting conditions; light traffic as well as medium and heavy traffic; static or moving objects including humans at various distances from the vehicle, and many other factors. Additionally, combinations of the above should be covered, and it may also be required that any such situation is covered in multiple video sequences.

Thus, it is clear that collecting the required footage is a huge task, and not a trivial one. While some situations, such as combinations of certain weathers and environments can be relatively easily obtained, others, such as a person bursting into a road while the sun is shining at the drivers' eyes while cross traffic is approaching are rarer and cannot be guaranteed to be collected, particularly within a given time period.

### BRIEF SUMMARY

One exemplary embodiment of the disclosed subject matter is a method of generating content for training a classifier, comprising: receiving two or more parts of a description; for each of the parts, retrieving from an extracted feature collection library one or more extracted feature collections derived from one or more video frames, the extracted feature collections or the video frames labeled with a label associated with the part, thus obtaining a multiplicity of extracted feature collections; and combining the multiplicity of extracted feature collections to obtain a combined feature collection associated with the description, the combined feature collection to be used for training a classifier. The method can further comprise training a video classifier on a corpus including the combined feature collection as labeled with the description. Within the method any of the extracted feature collections can be a two dimensional Fast Fourier Transform (FFT) of at least one video frame. Within the method any of the extracted feature collections can be a wavelet transformation of at least one video frame. Within the method any of the extracted feature collections can comprise an element selected from the group consisting of: geometrical parameters, color parameters; texture parameters; location parameters, and size parameters. The method can further comprise extracting the extracted feature collections from the video frames. Within the method, the video frames are optionally captured by a capturing device selected from the group consisting of: a video camera; an Infra-Red video camera; an imaging Radar and an imaging Lidar. The method can further comprise reconstructing one or more synthetic video frames from the combined feature collection, the synthetic video frames viewable by a human user.

Another exemplary embodiment of the disclosed subject matter is an apparatus for generating content for training a classifier the apparatus comprising: a processor adapted to perform the steps of: receiving two or more parts of a description; for each of the parts, retrieving from an extracted feature collection library one or more extracted feature collections derived from one or more video frames, the extracted feature collections or the video frames labeled with a label associated with the part, thus obtaining a multiplicity of extracted feature collections; and combining the multiplicity of extracted feature collections to obtain a combined feature collection associated with the description, the combined feature collection to be used for training a classifier. Within the apparatus, the processor is optionally further adapted to train a video classifier on a corpus including the combined feature collection as labeled with the description. Within the apparatus, the extracted feature collection is optionally a two dimensional Fast Fourier Transform (FFT) of at least one video frame. Within the apparatus, the extracted feature collection is optionally a wavelet transformation of at least one video frame. Within the apparatus, the extracted feature collection optionally comprises one or more elements selected from the group consisting of: geometrical parameters, color parameters; texture parameters; location parameters, and size parameters. Within the apparatus, the processor is optionally further adapted to extract the at least one extracted feature collection from the at least one video frame. Within the apparatus, the video frame is optionally captured by a capturing device selected from the group consisting of: a video camera; an Infra-Red video camera; an imaging Radar and an imaging Lidar. Within the apparatus, the processor is optionally further adapted to reconstruct one or more synthetic video frames from the combined feature collection, the synthetic video frames viewable by a human user.

Yet another exemplary embodiment of the disclosed subject matter is a computer program product comprising a non-transitory computer readable storage medium retaining program instructions configured to cause a processor to perform actions, which program instructions implement: receiving at two or more parts of a description; for each of the parts, retrieving from an extracted feature collection library one or more extracted feature collections derived from one or more video frame, the extracted feature collections or the video frames labeled with a label associated with the part, thus obtaining a multiplicity of extracted feature collections; and combining the multiplicity of extracted feature collections to obtain a combined feature collection associated with the description, the combined feature collection to be used for training a classifier.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic flowchart of a method of generating training materials for a video classifier, in accordance with some embodiments of the disclosure;

FIG. 2 is an exemplary illustration of the method of generating training materials for a video classifier, in accordance with some embodiments of the disclosure; and

FIG. 3 is a schematic block diagram of an apparatus for generating training materials for a video classifier, in accordance with some embodiments of the disclosure.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Certain image and video processing applications, and in particular vehicle related applications, such as autonomous cars or other driver-assisting systems need to be trained over huge amounts of video in order to classify situations correctly and retrieve the desired behavior.

One technical problem dealt with by the disclosed subject matter is the need to collect huge amount of video, covering almost any possible situation the application may need to handle. In the example of driver-assisting systems, such video collection may need to include captures of multiple instances of any situation, such as combinations of weathers, environments, lighting conditions, traffic, static or moving objects including people with various characteristics at various locations and distances from the vehicle, and many other factors. Capturing such videos is not always possible, as some of the cases cannot be arranged or simulated reliably.

Another technical problem dealt with by the disclosed subject matter is the need to obtain such video within a predetermined time frame, such that the classifier can be trained in due time. Even if all required situations are guaranteed to occur, which is generally not true, it may still take years to complete such corpus, which will unacceptably delay time to market.

One technical solution comprises the generation of training materials by combining existing materials. Thus, a multiplicity of existing videos or other image streams can be manually or automatically labeled to indicate the various conditions or contents, such as “snow”, “pedestrian crossing”, “night”, “heavy traffic”, or the like. Feature collections can then be extracted from one or more frames in each such stream. Feature examples may include wavelets, Fast Fourier Transform (FFT) features, or others. Each such extracted feature collection may be associated with the same or similar label or labels as the video from which the feature collections were extracted. The streams may be received from any source that captures optical or other images, such as but not limited to a video camera, an Infra-Red camera, an imaging radar, an imaging Lidar, or the like.

A user can then describe a situation which needs to be included in a training corpus, for example “a pedestrian crossing a crossover”.

The description can be split into its components, in this case “pedestrian” and “crossing a crossover”. Further components may relate to the terrain, the weather, the traffic load, or the like.

Extracted feature collections, each extracted from one or more frames can then be retrieved for each such component.

The extracted feature collections, each representing any component of the description, can then be combined, to create a combined feature collection complying with the description.

A classifier can then be trained upon the combined feature collections. Although classifiers usually receive input in the form of video sequences comprised of video frames, they extract features from the video frames and use the features. Thus, receiving the extracted feature collections rather than the video frames does not harm the training process, and may even make it faster.

A video sequence that can be watched and understood by a human user can be created from a multiplicity of combined feature collections, such that the user can check the video, for example in order to compare it against the description upon which it was created. While such video may be useful for a human viewer, this is not necessary.

One technical effect of the disclosed subject matter relates to the generation of “tailor made” training materials and not relaying only on situations that actually occurred and have been captured. This provides for more thorough training, which includes more cases of larger variety and coverage of the changing conditions, and thus provides for better classification and correct behavior. In the case of driver-assisting systems, this translates directly to increased safety. By not relying exclusively on authentic video capturing, the compilation of a feature library can take significantly less time and can be done on a much shorter time frame.

Another technical effect of the disclosed subject matter relates to increasing the efficiency of training a classifier. Since extraction of features from video frames is not required, the classifier can process the same amount of data on shorter time. Moreover, features take a fraction of the storage space relative to the corresponding video frames. Thus, extracting features from existing videos can save significant storage space.

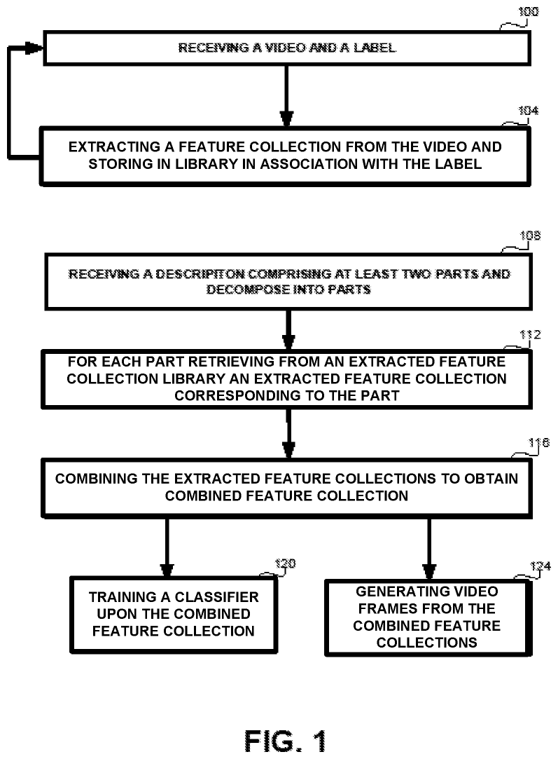

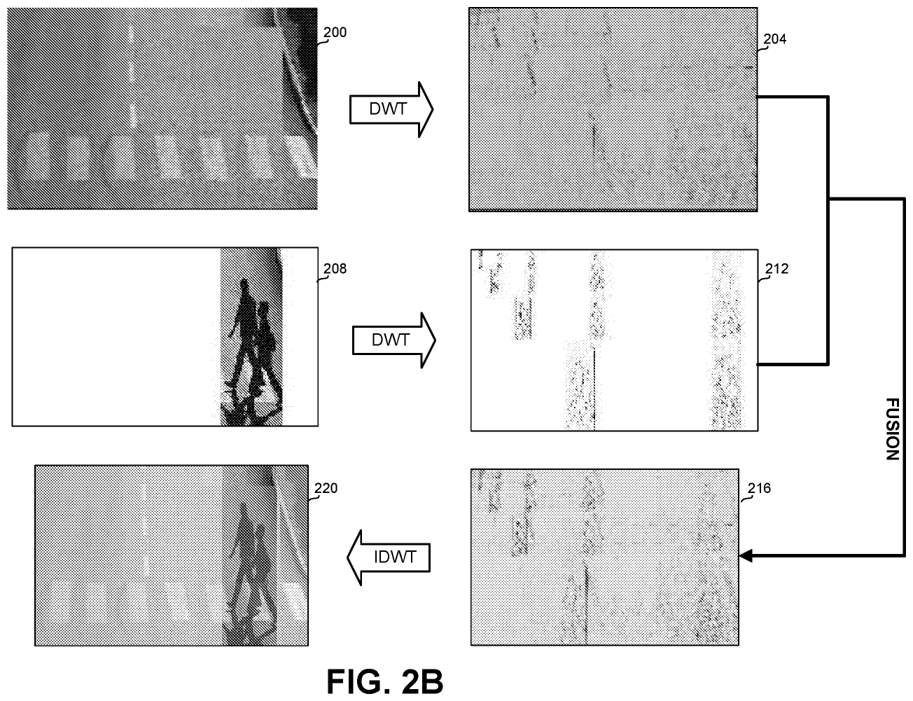

Referring now to FIG. 1, showing a schematic flowchart of a method of generating training materials for a video classifier, in accordance with some embodiments of the disclosure, and to FIG. 2, showing an exemplary illustration of the method.

On preliminary stages 100 and 104, a library of labeled extracted feature collections may be prepared.

On stage 100, a video stream or video sequence may be received from any source, including a video camera, an Infra-Red camera, an imaging Radar, an imaging Lidar or others, together with one or more labels describing the video sequence. The label may be assigned to the video automatically, manually, or semi-automatically wherein an automated system provides a label and a user may approve or change the label.

On stage 104, feature collections can be extracted from one or more frames of the video, and stored in a library together with the one or more labels. The library can be stored locally, remotely, or the like. In some embodiments each extracted feature collection may be derived from a single frame.

The process can be repeated for a multiplicity of videos form one or more sources. The labels can be assigned to the videos with a certainty degree, indicating for example the level to which the label describes the video.

The feature collections may be extracted in accordance with the input images and with the specific method being used, such as wavelet, Fast Fourier Transform (FFT), or the like.

Referring now to FIG. 2, demonstrating the usage of wavelet packet decomposition implemented by Discrete Wavelet Transform (DWT). Image 200 may be associated with a label of “crossover”. The extracted feature collection shown in image 204 is extracted from image 200 and stored in association with the label “crossover”. Similarly, image 208 may be associated with a label of “two people”. The extracted feature collections shown in image 212 can be extracted from image 208 and stored in association with the label “two people”, “two people crossing”, or the like. Depending on the specific implementation, wavelet features may be extracted by processing the images column-first followed by row processing, or row-first followed by column processing. Each such processing may be performed using low pass filter or high pass filter, thus outputting four matrices: low-low matrix, referred to as approximation matrix, low-high matrix which provides mainly the horizontal features of the image if the first processing is on rows and the second is on columns, and provides mainly the vertical features if the first processing is on columns and the second is on rows, high-low matrix which provides the features of the dimension other than the one provided by the low-high matrix, and high-high which provides the diagonal features. The filter type, e.g., the coefficients of the high or low pass filters may be determined in accordance with the used function, such as Harr, Mexican Hat, Meyer, Daubechies of any type such as db1, or the like.

It will be appreciated that second level (or further levels) decomposition can also be carried out, resulting in 16 (or 64 or more) matrices.

The feature extraction used in FIG. 2 is implemented using Discrete Wavelet Transform (DWT) which is comfortably visible. However, any other feature extraction may be used.

On step 108, a description of a required video, the description comprising at least two parts, terms, components, or the like may be received from a user and decomposed into its parts. The parts can be words, phrases, terms, parts of speech such as noun or verb, sub-sentences, or the like. For example, a description of “a pedestrian on a crossover on a snowy day” comprises the parts of “pedestrian”, “crossover” and “snowy day”.

On step 112, the extracted feature collection library can be searched for stored extracted feature collections associated with labels identical or similar to the parts of the description as decomposed. It will be appreciated that multiple extracted feature collections can be retrieved for each such part. For example, multiple video frames or sequences of footage captured on a snowy day and multiple video frames or sequences of footage captured depicting a crossover may be retrieved. The sequence used for each such part can be selected upon a certainty level associated with the description assigned to each sequence, with another parameter associated with the sequence such as quality, by preferring sequences associated with two or more parts of the description of the required video, videos that have been more or less in use, or the like. As detailed below, multiple combinations may also be used.

It will be appreciated that searching can include exact search or fuzzier search, for example with common spelling mistakes, singular/plural forms, or the like.

On step 116, the extracted feature collections related to the different parts of the description are fused. As shown in FIG. 2, image 216 is generated by fusing the extracted feature collections of images 204 and 212. In the wavelet example, fusing the extracted feature collections comprises combining corresponding matrices of the two images, such as the low-low matrix of one image with the low-low matrix of the other. The combination can a weighted sum, giving equal weight to the two images (resulting in an averaged image) or different weights, an average or weighted average, or the like. For example, if one of the images depicts humans, this image can be assigned a higher weight. In alternative embodiments, the higher value of the corresponding values in the two matrices can be selected for each entry in the matrix. In further embodiments, one of the two corresponding values can be selected randomly for each entry in the matrix.

It will be appreciated that further image fusions can be generated. For example, if two extracted feature collections are retrieved for “two people” and two extracted feature collections are retrieved for “crossover”, a total of four combined feature collections can be generated. Thus, the features of image 216 can be fused with further feature sequences, for example of an image labeled “show”, thus producing a combined feature collection relevant to the description of “two people crossing a crossover on a snowy day”.

On step 120, the combined feature collection, with a label identical or similar to the description or any combination of parts thereof may be used for training a classifier. Unlike training on video frames, no feature extraction is required, since the features are a-priori available.

The classifier can thus be trained upon and learn situations not captured by authentic video captures. This provides for faster collection of cases upon which the classifier is trained, and thus earlier availability of the classifier.

On step 124, a video image can be reconstructed upon one or more combined feature collections, for example by using the inverse transformation to the transformation used for extracting the features, for example Inverse Discrete Wavelet Transform (IDWT). In the example above, this transformation can take the sets of four matrices discussed (or 16 of two levels are used) and compose them into a video frame. The video frame can be used by a human user for evaluating the resulting feature combinations, or for any other purpose.

Image 220 shows the result of applying IDWT to image 216, and indeed shows two people on a crossover.

It will be appreciated that one extracted feature collection corresponding to one part of the description can be combined with each of a multiplicity of extracted feature collections corresponding to another part of the description. For example, an extracted feature collection associated with “snow” can be combined with each of a multiplicity of extracted feature collections describing a certain situation.

In further situations, each extracted feature collection corresponding to one part of the description can be combined with one of a multiplicity of extracted feature collections corresponding to another part of the description, such that the situations depicted in the two extracted feature collections advance in parallel.

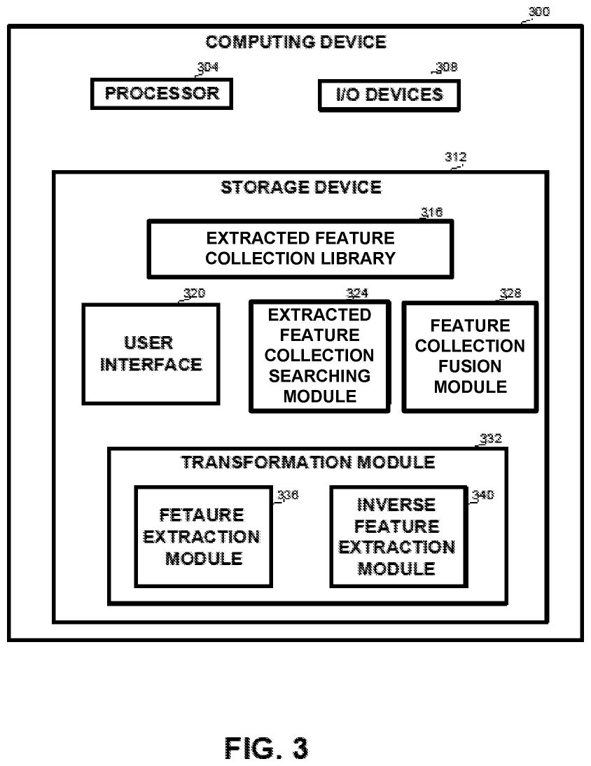

Referring now to FIG. 3, showing a schematic block diagram of an apparatus for generating training materials for a video classifier, in accordance with some embodiments of the disclosure.

The apparatus, may comprise a computing platform 300, which may comprise one or more processors 304. Any of processors 304 may be a Central Processing Unit (CPU), a microprocessor, an electronic circuit, an Integrated Circuit (IC) or the like. Alternatively, computing device 300 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processor 304 may be utilized to perform computations required by apparatus 300 or any of it subcomponents.

Computing device 300 may comprise one or more I/O devices 308 configured to receive input from and provide output to a user. In some embodiments I/O devices 308 may be utilized to present to a user the option to enter a description, to watch videos or feature sequences, or the like. I/O devices 308 can comprise output devices such as a display, speaker, or the like, and input devices such as keyboard, a mouse, a pointing device, a touch screen, a microphone, or the like.

Computing device 300 may comprise one or more storage devices 312 for storing executable components, and which may also contain persistent data or data stored during execution of one or more components. Storage device 312 may be persistent or volatile. For example, storage device 312 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 312 may retain data structures and program code operative to cause any of processors 304 to perform acts associated with any of the steps shown in FIG. 1 above.

The components detailed below, excluding extracted feature collection library 316 may be implemented as one or more sets of interrelated computer instructions, executed for example by any of processors 304 or by another processor. The components may be arranged as one or more executable files, dynamic libraries, static libraries, methods, functions, services, or the like, programmed in any programming language and under any computing environment.

In some exemplary embodiments of the disclosed subject matter, storage device 312, or another storage operatively connected thereto may comprise extracted feature collection library 316, which comprises collections of features extracted from video frames or generated in accordance with the disclosure. Each such extracted feature collection may be associated with one or more labels comprised of words or other indications.

In some exemplary embodiments of the disclosed subject matter, storage device 312 may comprise user interface 320 configured to display to a user over an output device of I/O devices 308 searching options, videos, or the like, and to receive instructions, selections, or the like from the user over any input device of I/O devices 308.

Storage device 312 may comprise extracted feature collection searching module 324 for decomposing a description into parts and searching for extracted feature collections associated with the description parts within feature sequence library 316.

Storage device 312 may comprise feature collection fusion module 328 for fusing or otherwise combining two or more feature collections, such as two or more extracted feature collections into a single feature collection.

Storage device 312 may comprise one or more transformation modules 332 comprising feature extraction module 336 for extracting features from one or more video frames, and a corresponding inverse feature extraction module 340 for generating one or more video frames from a feature collection.

It would be appreciated that feature collection fusion module 328, feature extraction module 336 and inverse feature extraction module 340 should correspond to each other and operate with the same features, such as wavelets, FFT, or the like. It will also be appreciated that multiple such sets of components including feature collection fusion module 328, feature extraction module 336 and inverse feature extraction module 340 can be present, each operating with different features can be provided, wherein the used features may be selected in accordance with user or automatic considerations, such as characteristics of available videos, processing time required, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). Each block may be implemented as a multiplicity of components, while a number of blocks may be implemented as one component. Even further, some components may be located externally to the car, for example some processing may be performed by a remote server being in computer communication with a processing unit within the vehicle. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of generating content for training a classifier, comprising:
receiving at least two parts of a description;
for each part of the at least two parts, retrieving from an extracted feature collection library at least one extracted feature collection derived from at least one video frame, the at least one extracted feature collection or the at least one video frame labeled with a label associated with the part, thus obtaining a multiplicity of extracted feature collections; and
combining the multiplicity of extracted feature collections to obtain a combined feature collection associated with the description, the combined feature collection to be used for training a classifier.

2. The method of claim 1, further comprising training a video classifier on a corpus including the combined feature collection as labeled with the description.

3. The method of claim 1, wherein the at least one extracted feature collection is a two dimensional Fast Fourier Transform (FFT) of at least one video frame.

4. The method of claim 1, wherein the at least one extracted feature collection is a wavelet transformation of at least one video frame.

5. The method of claim 1, wherein the at least one extracted feature collection comprises at least one element selected from the group consisting of: geometrical parameters, color parameters; texture parameters; location parameters, and size parameters.

6. The method of claim 1, further comprising extracting the at least one extracted feature collection from the at least one video frame.

7. The method of claim 1, wherein the at least one video frame is captured by a capturing device selected from the group consisting of: a video camera; an Infra-Red video camera; an imaging Radar and an imaging Lidar.

8. The method of claim 1, further comprising reconstructing at least one synthetic video frame from the combined feature collection, the at least one synthetic video frame viewable by a human user.

9. An apparatus for generating content for training a classifier the apparatus comprising:
a processor adapted to perform the steps of:
receiving at least two parts of a description;
for each part of the at least two parts, retrieving from an extracted feature collection library at least one extracted feature collection derived from at least one video frame, the at least one extracted feature collection or the at least one video frame labeled with a label associated with the part, thus obtaining a multiplicity of extracted feature collections; and
combining the multiplicity of extracted feature collections to obtain a combined feature collection associated with the description, the combined feature collection to be used for training a classifier.

10. The apparatus of claim 9, wherein the processor is further adapted to train a video classifier on a corpus including the combined feature collection as labeled with the description.

11. The apparatus of claim 9, wherein the at least one extracted feature collection is a two dimensional Fast Fourier Transform (FFT) of at least one video frame.

12. The apparatus of claim 9, wherein the at least one extracted feature collection is a wavelet transformation of at least one video frame.

13. The apparatus of claim 9, wherein the at least one extracted feature collection comprises at least one element selected from the group consisting of: geometrical parameters, color parameters; texture parameters; location parameters, and size parameters.

14. The apparatus of claim 9, wherein the processor is further adapted to extract the at least one extracted feature collection from the at least one video frame.

15. The apparatus of claim 9, wherein the at least one video frame is captured by a capturing device selected from the group consisting of: a video camera; an Infra-Red video camera; an imaging Radar and an imaging Lidar.

16. The apparatus of claim 9, wherein the processor is further adapted to reconstruct at least one synthetic video frame from the combined feature collection, the at least one synthetic video frame viewable by a human user.

17. A computer program product comprising a non-transitory computer readable storage medium retaining program instructions configured to cause a processor to perform actions, which program instructions implement:
receiving at least two parts of a description;
for each part of the at least two parts, retrieving from an extracted feature collection library at least one extracted feature collection derived from at least one video frame, the at least one extracted feature collection or the at least one video frame labeled with a label associated with the part, thus obtaining a multiplicity of extracted feature collections; and
combining the multiplicity of extracted feature collections to obtain a combined feature collection associated with the description, the combined feature collection to be used for training a classifier.
